(19) United States
(12) Patent Application Publication
(10) Pub. No.: US 2026/0132289 A1
(43) Pub. Date: May 14, 2026

(54) BINDER COMPOSITIONS AND METHODS OF MAKING THE SAME

(71) Applicant: HONEYWELL INTERNATIONAL INC., Charlotte, NC (US)

(72) Inventors: Yonghong Ruan, Wayne, NJ (US); Swapnil Kanaujia, Haryana (IN); Scott M. Hacker, River Edge, NJ (US); Anand Shankar S Mahadware, Haryana (IN)

(73) Assignee: HONEYWELL INTERNATIONAL INC., Charlotte, NC (US)

(21) Appl. No.: 19/351,317

(22) Filed: Oct. 7, 2025

Related U.S. Application Data
(60) Provisional application No. 63/719,171, filed on Nov. 12, 2024.

(51) Int. Cl. C08L 95/00

(52) U.S. Cl. CPC C08L 95/00; C08L 2205/03; C08L 2207/24; C08L 2555/22; C08L 2555/86

(57) ABSTRACT

Binder compositions and methods of producing the same are provided. In an exemplary embodiment, a binder composition includes asphalt and ground tire rubber particles. The ground tire rubber particles have a nominal product designation (Alternative US Sieve Size) defined by ASTM D5603-23 of equal or higher than about 200 mesh, and where the binder composition includes the ground tire rubber particles in an amount of from about 5 to about 14 weight percent, based on a total weight of the binder composition. the binder composition is stable.

### CROSS REFERENCE TO RELATED APPLICATION

This application claims the benefit of U.S. Provisional Application No. 63/719,171, filed Nov. 12, 2024.

### TECHNICAL FIELD

The present disclosure generally relates to binder compositions and methods of making the same. More particularly, the binder compositions comprise asphalt and ground tire rubber particles.

### BACKGROUND

Waste tires are a significant issue in the United States and the rest of the world. Waste tires include heavy metals and other pollutants which pose a risk when improperly disposed of. The large volume of waste tires can take up significant space in landfills. Many tires are incinerated for energy, mostly in cement kilns, but such incineration produces off-gases, and the resulting ash can be toxic and poses its own disposal considerations. Some waste tires are ground up and subsequently “devulcanized” by high shear and high heat, or high pressure and high heat, where sulfur crosslinking bonds may be broken to produce a mass that can be incorporated into asphalt for paving, roofing, or other purposes. However, this involves high energy use and specialized equipment, which involves increased capital and operating costs. Other products are also produced from waste tires, such as recycled tire turfs, artificial reefs, backfill for retaining walls, etc. However, the quantity of waste tires produced far exceeds the current uses.

Accordingly, it is desirable to find materials and processes that improve the incorporation and use of waste tires. In addition, it is desirable to find materials and processes for incorporating waste tires into binder compositions to produce a stable product, while minimizing heating and energy costs associated with high shear equipment. Furthermore, other desirable features and characteristics of the present embodiment will become apparent from the subsequent detailed description and the appended claims, taken in conjunction with this background.

### BRIEF SUMMARY

Binder compositions and methods of producing the same are provided. In an exemplary embodiment, a binder composition includes asphalt and ground tire rubber particles. The ground tire rubber particles have a nominal product designation (Alternative US Sieve Size) defined by ASTM D5603-23 of equal or higher than about 200 mesh. The binder composition includes the ground tire rubber particles in an amount of from about 5 to about 14 weight percent, based on a total weight of the binder composition, the binder composition is stable.

A method of producing a binder composition is provided in another embodiment. The method includes combining asphalt and ground tire rubber particles to produce a premix asphalt material. The ground tire rubber particles have a nominal product designation (Alternative US Sieve Size) defined by ASTM D5603-23 of equal or higher than about 200 mesh. The binder composition includes the ground tire rubber particles in the premix asphalt material in an amount of from about 5 to 14 weight percent, based on a total weight of the premix asphalt material. The premix asphalt material is mixed to form the binder composition.

Another binder composition is provided in yet another embodiment. The binder composition includes asphalt in an amount of from about 20 to about 85 weight percent, based on a total weight of the binder composition. The binder composition also include ground tire rubber particles having a nominal product designation (Alternative US Sieve Size) defined by ASTM D5603-23 of equal or higher than about 200 mesh, where the ground tire rubber particles are present in the binder composition in an amount of from about 5 to about 14 weight percent, based on the total weight of the binder composition. Polyolefin is present in the binder composition in an amount of from about 1 to about 10 weight percent, based on the total weight of the binder composition. The binder composition is stable.

### DETAILED DESCRIPTION

The following detailed description is merely exemplary in nature and is not intended to limit the various embodiments or the application and uses of the embodiments described herein. Furthermore, there is no intention to be bound by any expressed or implied theory presented in the preceding technical field, background, brief summary, or the following detailed description.

### Ground Tire Rubber

Ground tire rubber can be incorporated into asphalt, but the resulting product tends to be unstable because the ground tire rubber particles settle out. However, it has been discovered that ground tire rubber particles can be incorporated into asphalt if the particles size is small enough, and the concentration of the ground tire rubber particles is within acceptable limits. In some embodiments, the ground tire rubber particles are vulcanized rubber, and the vulcanized ground tire rubber has been successfully incorporated into asphalt with the proper particle size. Higher concentrations of ground tire rubber particles tend to product higher viscosities, where higher viscosities make the product hard to work with. The performance grade (PG) of the resulting binder composition can be improved with the addition of certain polyolefins, so that the binder composition can be used for projects that require a higher performance grade asphalt.

Waste tires are cleaned, ground into smaller pieces, and screened to obtain ground tire rubber particles (sometimes referred to as “crumb rubber”). Metal objects in the ground tire rubber can be removed with magnets, and other process steps may be utilized in various embodiments. In general, ground tire rubber particles are commercially available in a variety of sizes. According to ASTM D5603-23, “Standard Classification for Rubber Compounding Materials—Recycled Vulcanizate Rubber,” exemplary nominal product designations of ground tire rubber particles include 20 mesh crumb rubber (850 micron); 30 mesh crumb rubber (600 micron); 40 mesh crumb rubber (425 micron); 60 mesh crumb rubber (250 micron); 80 mesh crumb rubber (180 micron); 100 mesh crumb rubber (150 micron); 120 mesh crumb rubber (125 micron); 140 mesh crumb rubber (106 micron); 200 mesh crumb rubber (75 micron); 325 mesh crumb rubber (45 micron); 400 mesh crumb rubber (38 micron); 450 mesh crumb rubber (32 micron); 500 mesh crumb rubber (25 micron); and 635 mesh crumb rubber (20 micron). Other crumb rubber nominal product designations are also available. Crumb rubber “nominal product designation”, as used herein, refers to crumb rubber products which meet requirements listed in ASTM D5603-23 Table 2A and 2B. For example, the 140 mesh crumb rubber product will have maximum 2% retained on a 100 mesh sieve and maximum 15% retained on a 140 mesh sieve.

A binder composition includes asphalt and ground tire rubber particles having a nominal product designation (Alternative US Sieve Size) defined by ASTM D5603-23 of equal or higher than about 200 mesh, which includes 230 mesh, 270 mesh, 325 mesh, 400 mesh, 450 mesh, 500 mesh, 635 mesh, and higher mesh numbers. It has been discovered that ground tire rubber particles with a nominal product designation (Alternative US Sieve Size) defined by ASTM D5603-23 of equal or higher than about 200 mesh, which includes 230 mesh, 270 mesh, 325 mesh, 400 mesh, 450 mesh, 500 mesh, 635 mesh, and higher mesh numbers will remain stable in the binder composition if the concentration of the ground tire rubber particles is less than about 14 weight percent, based on a total weight of the binder composition. Ground tire rubber particles concentrations of 15 weight percent were found to be unstable, and concentrations of 12 weight percent were found to be stable, so the actual limit is somewhere between 12 and 15 weight percent, where the weight percents are based on a total weight of the binder composition. The ground tire rubber particles are not “devulcanized,” such that the vulcanizate network of the ground tire rubber particles remains largely in-tact. The sulfur bonds in the ground tire rubber remain largely in place, and the ground tire rubber particles remain in the binder composition in a stable manner at a nominal product designation (Alternative US Sieve Size) defined by ASTM D5603-23 of equal or higher than about 200 mesh, for example, 230 mesh, 270 mesh, 325 mesh, 400 mesh, 450 mesh, 500 mesh, 635 mesh, etc.

The ground tire rubber particles may be present in the binder composition in an amount of from about 5 to about 14 weight percent, based on a total weight of the binder composition. In alternate embodiments, the ground tire rubber particles may be present in the binder composition in an amount of from about 8 to about 14 weight percent, or 8 to about 12 weight percent, or 10 to about 12 weight percent, or at most 12 weight percent, all based on the total weight of the binder composition. The ground tire rubber used in this invention can be any of the Classification 1, 2, 3, 4, 5, 6, 7 and 8 defined by ASTM D5603-23.

### Asphalt

Binder compositions described herein may be used for a variety of purposes. In some embodiments, the binder compositions are intended for use in road construction or other paving purposes, and most of the following description is directed towards such paving binder compositions. However, the binder compositions described herein may also be used for roofing materials, including asphalt shingles and asphalt roofing membranes. The binder compositions may also be used for certain waterproofing products, such as waterproof membranes suitable for application to bridges, parking structures, promenade decks, pedestrian trails, bicycle trails, crawl space barriers, below grade structures, etc. The concentration of the asphalt, various additive(s), the amount and quality of aggregate, and other components may vary for different uses. In general, the binder compositions described herein are used as a binder for a final product, where the final product also includes aggregate. As such, the description is primarily limited to the binder portion of the paving products, roofing products, or other types of products that may utilize the described binder.

Bitumen is a component of the binder. The term “bitumen,” as used herein, is as defined by the ASTM D8 and is a dark brown to black cement-like material in which the predominant constituents are bitumens that occur in nature or are obtained in petroleum processing. Bitumens characteristically contain saturates, aromatics, resins and asphaltenes, and as such are organic in nature. The terms “asphalt” and “bitumen” are often used interchangeably to mean both natural and manufactured forms of the material, which are all within the scope of the compositions and methods contemplated and described herein.

The type of bitumen suitable for use in the compositions and methods contemplated and described herein are not particularly limited and include any naturally occurring, synthetically manufactured and modified bitumens known now or in the future. Naturally occurring bitumen is inclusive of native rock asphalt or bitumen such as Buton asphalt, a uintaite material, lake asphalt, and the like. Synthetically manufactured bitumen is often a byproduct of petroleum refining operations and includes air-blown bitumen, blended bitumen, cracked or residual bitumen, petroleum bitumen, propane bitumen, straight-run bitumen, thermal bitumen, and the like. A bitumen-based binder includes some types of bitumen (e.g., neat or unmodified bitumen that can be naturally occurring or synthetically manufactured) and may be modified with a wide variety of different components. Exemplary additives include, but are not limited to, elastomers, processing oils, tackifiers, phosphoric acid, polyphosphoric acid, plastomers, antioxidants, reclaimed asphalt pavement (RAP), reclaimed asphalt shingles (RAS), and other materials, or various combinations of these modifiers.

Furthermore, industry-grade bitumen, including without limitation, paving-grade bitumen, are advantageous for use in the compositions and methods contemplated and described herein. Non-exclusive examples of paving-grade bitumens include, but are not limited to, bitumens (or asphalts) having any one of the following performance grade ratings: PG 46-40, PG 46-34, PG 52-40, PG 52-34, PG 52-28, PG-58-40, PG 58-34, PG 58-28, PG 58-22, PG 64-40, PG 64-34, PG 64-28, PG 64-22, PG 64-16, PG 64-10, PG 67-22, PG 70-40, PG 70-34, PG 70-28, PG 70-22, PG 70-16, PG 70-10, PG 76-34, PG 76-28, PG 76-22, PG 76-16, PG 76-10, PG 82-22, PG 82-16, PG 82-10, PG 88-22, PG 88-16, and PG 88-10. Additionally, non-exclusive examples of paving-grade bitumens within the scope of the present disclosure include, but are not limited to, paving-grade bitumens (or asphalts) having any one of the following penetration grades: 50/70, 60/70, 60/90, 70/100, 80/110, 120/150, 150/180, 150/200, 160/220, 200/300, and 300+ dmm penetration. Additionally, non-exclusive examples of paving-grade bitumens within the scope of the present disclosure include, but are not limited to, paving-grade bitumens (or asphalts) having any one of the following viscosity grades: VG-10, VG-20, VG-30, VG-40, AC-5, AC-10, AC-20, AC-30, etc.

It is contemplated that industry-grade bitumen, such as roof-grade asphalt or bitumen, may be advantageously used in the waterproof compositions contemplated and described herein. In such embodiments, the binder compositions will be useful for roofing applications or other waterproofing applications. Suitable roofing-grade bitumens include, but are not limited to, bitumens having any one of the following penetration grades: 30/50, 50/70, 60/90, 70/100, 80/110, 120/150, 150/180, 150/200, 160/220, 200/300, and 300+ deci-millimeters penetration (dmm pen). Penetration grades are determined per the test method described in ASTM D5. In some embodiments of the roofing and waterproofing composition, the bitumen is present at a concentration of from about 20 to about 85 weight % (wt. %), based on the total weight of the roof-grade asphalt.

Bitumen may be present at different concentrations in the different waterproof binder compositions described herein (i.e., the binder compositions useful for (i) self-adhering membranes, (ii) shingles, or (iii) other waterproof compositions.) The asphalt may be present in the binder composition in an amount of from about 20 to about 85 weight percent, based on a total weight of the binder composition. In alternate embodiments, the asphalt may be present in an amount of from about 25 to 85 weight percent, or from about 30 to about 70 weight percent, based on the total weight of the binder composition.

### Polyolefin

Polyolefin may be added to the binder composition, where the polyolefin improves the performance and/or grade of the binder composition. The polyolefin primarily includes a low molecular weight (LMW) polyolefin, where the “low molecular weight,” as used herein, means a weight average molecular weight of from about 500 to about 30,000 Daltons. The low molecular weight polyolefin is an olefin-containing polymer, or a blend of two or more olefin-containing polymers, each of which has a weight average molecular weight (M_{w}) of from about 500 to about 30,000 Daltons, and comprises one or more olefinic monomers, where the olefinic monomers are selected from: ethene, propene, butene, hexene, and octene. Thus, the LMW polyolefins may be homopolymers comprising only a single type of olefin monomer, or copolymers comprising two or more types of olefin monomers. Furthermore, LMW polyolefins, as this term is used herein, include but are not limited to polyolefin waxes, i.e., polyolefins which are solid at or near room temperature and have low viscosity when above their melting point. Some Fischer-Tropsch waxes, i.e., those that satisfy the above-defined characteristics of low molecular weight polyolefins but are produced from carbon monoxide and hydrogen, may also be used in the binder compositions contemplated and described herein.

Thermally degraded waxes are also examples of LMW polyolefins, where the thermally degraded waxes have a weight average molecular weight with the limit of from about 500 to about 30,000 Daltons, as mentioned above. The thermally degraded waxes may be formed from virgin polymers or recycled polymers in various embodiments. The low molecular weight polyolefins may be functionalized in some embodiments, where the low molecular weight polyolefin may be a functionalized homopolymer or a copolymer. In an exemplary embodiment, functionalized low molecular weight polyolefins comprise one or more functional groups including, but not limited to, an acid, an ester, an amine, an amide, an ether, and an anhydride such as maleic anhydride. Additionally, the low molecular weight polyolefins may be produced from oxidizing low and high molecular weight polyolefins.

In an exemplary embodiment, the LMW polyolefins is an oxidized high density polyethylene. Unoxidized high density polyethylene has a density of from about 0.93 to about 0.97 grams per cubic centimeter (g/cc) or higher, and oxidized high density polyethylene has a density equal to or greater than the unoxidized high density polyethylene depending on the degree of oxidation. An exemplary oxidized high density polyethylene has a density of at least 0.93, 0.94, 0.95, 0.96, 0.97, 0.98, 0.99, or 1.00 g/cc. In contrast, low density unoxidized polyethylene has a density of from about 0.91 to about 0.93 g/cc. Oxidized low density polyethylene also has a density of about 0.93 g/cc, as the term is used herein. Low density polyethylene tends to include multiple branches in the polymer chain, whereas high density polyethylene has minimal polymer branching. Oxidized polyethylene is a reaction product of polyethylene with oxygen-containing gases, and may be produced by different techniques. Oxidized polyolefins will have an acid number, defined as the amount of potassium hydroxide in milligrams required to neutralize 1 gram of polyolefin under fixed conditions. One set of fixed conditions, for example, would be ASTM 1386-83.

In an exemplary embodiment, the low molecular weight polyolefin has an olefin content of from about 50 to 100 wt. %, based on the total weight of the low molecular weight polyolefin. An exemplary low molecular weight polyolefin has an olefin content in wt. %, based on the total weight of the low molecular weight polyolefin, of at least about 55, 60, 65, 70, 75, 80, 85, 90, or 95 wt. %, and independently, of not more than about 100, 98, 95, 92, 90, 85, 80, or 75 wt. %.

As already mentioned, in an exemplary embodiment the low molecular weight polyolefin has a weight average molecular weight (M_{w}) of from about 500 to about 30,000 Daltons. In various embodiments the low molecular weight polyolefin has a M_{w} in Daltons of at least about 500, 1,000, 2,000, 3,000, 4,000, 5,000, 6,000, 7,000, 8,000, or 9,000 and independently, of not more than about 30,000, 20,000, 15,000, 12,000, or 10,000. Where the low molecular weight polyolefin comprises a combination of more than one type of polyolefin, the M_{w} of each type of polyolefin in the combination may individually be within the above-stated range of about 500 to about 30,000 Daltons. The weight average molecular weight of the low molecular weight polyolefins of the present disclosure may be determined by gel permeation chromatography (GPC), which is a technique generally known in the art. For the purpose of GPC, the sample to be measured may be dissolved in 1,2,4-trichlorobenzene at about 140° C. and at a concentration of about 2.0 mg/ml. The solution (200 microliters (μL)) is injected into the GPC containing two PLgel 5 micrometer (μm) Mixed-D (300×7.5 mm) columns held at about 140° C. with a flow rate of about 1.0 mL/minute. The instrument may be equipped with two detectors, such as a refractive index detector and a viscosity detector. The molecular weight (weight average molecular weight, Mw) is determined using a calibration curve generated from a set of linear polyethylene narrow molecular weight standards.

Generally, suitable low molecular weight polyolefins include, without limitation, polyethylene homopolymers, polypropylene homopolymers, ethylene vinyl acetate (EVA), ethylene butyl acrylate (EBA), ethylene acrylic acid (EAA), Fischer-Tropsch waxes, thermally degraded waxes with virgin or waste plastic feedstocks, by-product waxes, copolymers of two or more of ethylene, propylene, butene, hexene and octene, functionalized derivatives of the homopolymers mentioned above, functionalized derivatives of the copolymers mentioned above, or combinations of unfunctionalized and functionalized low molecular weight polyolefins. Some Fischer-Tropsch waxes, i.e., those that satisfy the above-defined characteristics of low molecular weight polyolefins but are produced from carbon monoxide and hydrogen, may also be used in the binder compositions contemplated and described herein. Examples of suitable functionalized low molecular weight polyolefins include, without limitation, maleated polyethylene, maleated polypropylene, ethylene acrylic acid copolymers, ethylene vinyl acetate copolymers, oxidized polypropylene, oxidized polyethylene, including oxidized low and/or high molecular weight polyethylene, and combinations thereof.

In an exemplary embodiment, the low molecular weight polyolefin is selected from the group of polyethylene, oxidized polyethylene with an acid number of from about 5 to about 60 milligrams potassium hydroxide per gram (mg KOH/gm), polypropylene, maleated polypropylene, and combinations thereof. In one example, the polyolefin is a maleated polypropylene with an acid number of from about 5 to about 50 mg KOH/gm. In alternate embodiments, the low molecular weight polyolefin is polyethylene, or oxidized polyethylene, or polypropylene, or maleated polypropylene, a co-polymer of ethylene and propylene, or combinations thereof.

In embodiments where the binder composition is to be used for paving, the polyolefin may be present in the binder composition in an amount of from about 0.5 to about 10 weight percent, based on the total weight of the binder composition. In alternate embodiments, the polyolefin may be present in an amount of from about 0.5 to about 5 weight percent, or from about 0.5 to about 3 weight percent, or 0.5 to about 2 weight percent. In embodiments where the binder composition is intended for roofing applications, the polyolefin may be present in the binder composition in an amount of from about 1 to about 10 weight percent, based on the total weight of the binder composition. In alternate embodiments, the polyolefin may be present in an amount of from about 2 to about 9 weight percent, or from about 4 to about 8 weight percent, all based on the total weight of the binder composition.

### Additional Components

The binder composition may optionally include several additional additives or components for various embodiments. For example, the binder composition may include fire retardant materials or flame retardant materials, such as halogenated flame retardants (for example, chlorinated flame retardants (CFRs), brominated flame retardants (BFRs)), phosphorus flame retardants (PFRs), nitrogen-base flame retardants (NFRs), inorganic flame retardants (for example, compounds based on nitrogen, graphite, silica, ammonium phosphate, polyphosphate, clay, carbon black, metal oxides, hydroxides, etc.), and combinations thereof. The binder composition may also, or alternatively, include anti-fungal materials, such as inorganic algaecides (for example, metals (copper, zinc, silver, etc.), metal oxides (cuprous oxides, zinc oxide, titanium dioxide, etc.), copper-containing compounds, zinc-containing compounds, silver-containing compounds, etc., organic algaecides (for example, didecyl dimethyl ammonium chloride, sodium dimethyldithiocarbamate, etc.), and combinations thereof.

Other optional ingredients include, but are not limited to, anti-oxidants, such as inorganic anti-oxidants (for example, carbon black, hydrated lime, calcium hydroxide, etc.), and organic anti-oxidants (for example, polyphenols, tocopherols, sterically hindered phenols, aromatic amines, zinc diethyldithiocarbamate, zinc dithiocarbonates, organic phenylamines, phenothiazine, phosphites, thioesters, lignins, ascorbic acids, etc.), and combinations thereof. Other optional ingredients include light stabilizers, such as UV absorbers (for example, benzophenones, benzotriazoles, etc.), nickel quenchers, hindered amine light stabilizers (HALS), etc., and combinations thereof. Oils may also optionally be employed. Exemplary oils include, but are not limited to, flux oils, paraffin, aromatic and naphthenic oils, bio-oils, corn oils, soybean oils, tall oils, reclaimed oil, recycled engine oils, recycled engine oil bottom (REOB), and combinations thereof.

Additional additives such as plasticizers are well-known in the industry for use in binder compositions, and these additives may expand the temperature ranges at which binder compositions can be used without serious defect or failure. Exemplary plasticizers include hydrocarbon oils (e.g., paraffin, aromatic and naphthenic oils), long chain alkyl diesters (e.g., phthalic acid esters, such as dioctyl phthalate, and adipic acid esters, such as dioctyl adipate), sebacic acid esters, glycol, fatty acids, phosphoric and stearic esters, epoxy plasticizers (e.g., epoxidized soybean oil), polyether and polyester plasticizers (which may also be polymers), alkyl monoesters (e.g., butyl oleate), long chain partial ether esters (e.g., butyl cellosolve oleate), and others.

The binder compositions contemplated herein may optionally comprise one or more other polymers, which may be present in a total amount of from about 0.5 to about 30 wt. %, based on the total weight of the binder composition. Non-limiting examples of polymers suitable for modifying the binder compositions contemplated herein include natural or synthetic rubbers including butyl rubber, styrene/butadiene rubber (SBR), styrene/ethylene/butadiene/styrene terpolymers (SEBS), polybutadiene, polyisoprene, ethylene/propylene/diene (EPDM) terpolymers, and styrene/conjugated diene block or random copolymers, such as, for example, styrene/butadiene including styrene/butadiene/styrene copolymer (SBS), styrene/isoprene, styrene/isoprene/styrene (SIS) and styrene/isoprene-butadiene block copolymer. The block copolymers may be branched or linear and may be a diblock, triblock, tetrablock or multiblock. The binder composition may optionally include the polymers listed above, as well as other polymers used to improve performance.

The binder compositions contemplated herein may optionally also include additional waxes (where the waxes may also be polymers), tackifiers, processing aids, UV protecting additives, etc. Exemplary non-exclusive waxes include ethylene bis-stearamide wax (EBS), Fischer-Tropsch wax (FT) (outside the definition of a “polyolefin” provided herein), oxidized Fischer-Tropsch wax (FTO) (outside the definition of a “polyolefin” provided herein), alcohol wax, silicone wax, petroleum waxes such as microcrystalline wax or paraffin, natural waxes, and other synthetic waxes. Exemplary tackifiers include rosins and their derivatives; terpenes and modified terpenes; aliphatic, cycloaliphatic and aromatic resins (C5 aliphatic resins, C9 aromatic resins, and C5/C9 aliphatic/aromatic resins); hydrogenated hydrocarbon resins; terpene-phenol resins; and combinations thereof.

The additional optional ingredients mentioned above, as well as other optional additional ingredients that are not specifically mentioned, may be present in the asphalt additive in an amount of from about 0.1 to about 10 weight percent, based on the total weight of the binder composition.

The binder composition may be combined with a filler for use as a paving material, or for use as a roofing material. A wide range of materials may be used for the filler, and the skilled artisan can select a filler appropriate for the intended use. The concentration of the binder composition in the final product will depend on the intended use, the grade, and other factors known to those skilled in the art.

In some embodiments, the asphalt is also free of certain components. The term “free of,” as used herein, means the named component is present in an amount of about 0.1 weight percent or less, based on a total weight of the material that is free of a named component. The asphalt may be free of certain elastomers, and the crosslinking agents that typically are associated with specific elastomers. For example, the asphalt may be free of styrene-butadiene-styrene (SBS), and/or styrene-butadiene (SB). The asphalt may also be free of sulfur, which is a common crosslinking agent used with SBS and/or SB. Reference herein to the asphalt being free of SBS, SB, and/or sulfur refers to the asphalt component, and does not refer to the SBS, SB, and/or sulfur that may be present in the ground tire rubber. As such, asphalt may be free of SBS, SB, and/or sulfur, where the binder composition may include SBS, SB, and/or sulfur as a component of the ground tire rubber particles.

### Binder Composition Performance

The binder composition is stable, where a stable binder composition indicates the top and bottom portions of the binder composition have about the same physical properties, such as softening point, penetration, viscosity, stiffness, modulus, etc. In this description, a “stable binder” is defined by a top sample and a bottom sample have complex modulus', (indicated by the symbol G*) with a difference of about 20% or less. If the binder compositions' top complex modulus and the bottom sample complex modulus are within about 20% of each other, (defined by the absolute value of the (top sample complex modulus—the bottom sample complex modulus) divided by the bottom sample complex modulus, the binder composition is considered stable, regardless of which of the top and bottom samples have the higher complex modulus value. The top and bottom samples are obtained using ASTM D7173 (cigar tube test). The asphalt sample is placed in an aluminum tube and stored at 163° C. for 48 hours. The tube is transferred to a freezer for 4 hr at −10±10° C. The tube is removed from the freezer and cut into three equal segments. The asphalt in the top and bottom segments are used for the analysis. The complex modulus is determined from ASTM D7175, Standard Test Method for Determining the Rheological Properties of Asphalt Binder Using a Dynamic Shear Rheometer; G*/sin(delta). A value of greater than or equal to 1.00 kilo Pascals (kPa) is considered a passing value, at the performance grade (PG) temperature of interest, for example, 64°, 70°, 76°, 82° C., etc.

Another important parameter for the binder composition is its workability, processibility, or pumpability, which is determined by the binder's viscosity at or around about 135° C. following ASTM D4402. It is well accepted by the world paving industry that a binder's viscosity at or around 135° C. should be below about 3000 centipoise (cPs) for it to have acceptable workability, processibility, or pumpability. Viscosities above about 3,000 cPs produce a binder with poor workability, processibility, and/or pumpability.

The binder composition may be graded for traffic loads. For example, a performance grade—multiple stress creep and recovery (PG-MSCR) rating can be determined by American Association of State Highway and Transportation Officials (AASHTO) test M332, the Standard Specification for Performance-Graded Asphalt Binder Using Multiple Stress Creep Recovery (MSCR) Test. A rating of “S” stands for “standard” traffic loads, a rating of “H” stands for “heavy traffic loads,” a rating of “V” stands for “very heavy traffic loads,” and a rating of “E” stands for “extremely heavy traffic loads.” The ratings are, in order from lowest to highest traffic loads, S, H, V, and E. Many applications call for binder compositions with a “V” rating or an “E” rating, such as for interstate highways and airport runways.

A rolling think-film oven (RTFO) test is conducted following ASTM test D2872, the Standard Test Method for Effect of Heat and Air on a Moving Film of Asphalt (Rolling Thin-Film Oven Test). A value of greater than, or equal to, 2.20 kilopascals (kPa) is considered a passing value, at the performance grade (PG) temperature of interest, for example, 64°, 70°, 76°, 82° C., etc. A multiple stress creep and recovery test (MSCR) is administered according to ASTM D7405, the Standard Test Method for Multiple Stress Creep and Recovery (MSCR) of Asphalt Binder Using a Dynamic Shear Rheometer. The test is performed on a binder sample conditioned using a rolling thin-film oven (RTFO) following ASTM test D2872, the Standard Test Method for Effect of Heat and Air on a Moving Film of Asphalt (Rolling Thin-Film Oven Test). The Jnr at 3.2 kPa is the non-recoverable creep compliance at 3.2 kPa. A value of less than or equal to 4.5 kPa⁻¹ is considered a passing “S” grade, a value of less than or equal to 2.0 kPa⁻¹ is considered a passing “H” grade, a value of less than or equal to 1.0 kPa⁻¹ is considered a passing “V” grade, a value of less than or equal to 0.5 kPa⁻¹ is considered a passing “E” grade, at testing temperatures defined by ASTM D7405. A Jnr diff. is the difference in non-recoverable creep compliance (Jnr) between 0.1 kPa and 3.2 kPa divided by Jnr at 0.1 kPa. A Jnr diff. value of less than or equal to 75% is considered a passing value. An elastic recovery (ER) test is performed by the AASHTO test method T-301, by employing a ductilometer. The ER attempts to identify the existence of an elastomer in modified asphalt and it is measured at various temperatures depending on the state or country's specification.

The softening point test is conducted following ASTM test method D36, the Standard Test Method for Softening Point of Bitumen. A ring-and-ball apparatus is used for the test. A value between 88 and 160° C. is considered passing for roofing shingle applications. The penetration test is conducted following ASTM test method D 5, the Standard Test Method for Penetration of Bituminous Materials. A minimum value of 15 minutes is considered passing for roofing shingle applications.

The binder composition should pass all the tests listed above at desirable temperatures, such as the performance grade (PG) temperatures of interest, for example, 64°, 70°, 76°, 82° C., etc., to be considered acceptable for use in road construction. The higher the grade for the PG-MSCR test, the more valuable the binder composition. These test values are indicated in Tables 1 and/or 2, below.

### Method of Production

The method for producing the binder composition includes combining the asphalt, the ground tire rubber particles, and any other components that may be present, to form a premix asphalt material. The premix asphalt material is then mixed to produce the binder composition. In exemplary examples, a polyolefin is added to the premix or the binder composition to make it comply with paving and roofing specifications. The mixing of the premix asphalt material may utilize a mixing temperature and mixing equipment that maintains a mixing shear, mixing temperature, and mixing time at levels below those required to dissociate the vulcanizate network of the ground tire rubber particles.

### Examples

Several experiments were conducted as documented below. As can be seen, the ground tire rubber particles (GTR) can be incorporated into the composition in a stable manner, at 12 weight percent, only when the GTR has a nominal product designation (Alternative US Sieve Size) defined by ASTM D5603-23 of equal or higher than about 200 mesh, which includes 230 mesh, 270 mesh, 325 mesh, 400 mesh, 450 mesh, 500 mesh, 635 mesh, and higher mesh numbers. It is possible that GTR with a nominal product designation (Alternative US Sieve Size) defined by ASTM D5603-23 between about 140 mesh and about 200 mesh may remain stable, but the experimental data only shows success with a nominal product designation (Alternative US Sieve Size) defined by ASTM D5603-23 of about 200 mesh or higher. Also, the grade of the asphalt is improved by the addition of the polyolefin. The higher grade of V, for “very heavy loads,” is required for many paving applications, such as for airport runways, major interstate highways, and other demanding paving environments.

TABLE 1

| | | Blend | Blend | Blend | Blend | Blend | Blend |
|---|---|---|---|---|---|---|---|
| Composition | | #1 | #2 | #3 | #4 | #5 | #6 |
| Base Bitumen (NA PG 64-22) | | 88.00% | 88.00% | 88.00% | 85.00% | 82.00% | 87.00% |
| GTR (80 mesh) | | 12.00% | | | | | |
| GTR (140 mesh) | | | 12.00% | | | | |
| GTR (200 mesh) | | | | 12.00% | 15.00% | 18.00% | 12.00% |
| SBS | | | | | | | |
| Honeywell Titan ® | | | | | | | 1.00% |
| 7686¹ | | | | | | | |
| Total | | 1.00 | 1.00 | 1.00 | 1.00 | 1.00 | 1.00 |
| Original Binder | Temp | | | | | | |
| | (° C.) | | | | | | |
| Brookfield Viscosity | 135 | 2590 | 2610 | 2450 | 4480* | 6800* | 2410 |
| (cPs) (<=3000) | | | | | | | |
| G*/sin(δ) (kPa) | 70 | 4.04 | 3.34 | 3.19 | 4.63 | 6.44 | 4.29 |
| (>=1.00) | | | | | | | |
| G*/sin(δ) (kPa) | 76 | 2.15 | 1.74 | 1.64 | 2.45 | 3.43 | 2.19 |
| (>=1.00) | | | | | | | |
| RTFO Residue | Temp | | | | | | |
| | (° C.) | | | | | | |
| G*/sin(δ) (kPa) | 70 | 6.78 | 5.79 | 5.61 | 6.84 | 9.41 | 7.79 |
| (>=2.20) | | | | | | | |
| G*/sin(δ) (kPa) | 76 | 3.75 | 3.10 | 2.99 | 3.69 | 5.25 | 4.14 |
| (>=2.20) | | | | | | | |
| MSCR on RTFO | Temp | | | | | | |
| Residue | (° C.) | | | | | | |
| Jnr 3.2 kPa (<=4.5) | 70 | 0.916 | 1.218 | 1.356 | 0.900 | 0.685 | 0.913 |
| Jnr Diff (<=75%) | 70 | 56.77 | 51.99 | 51.40 | 64.82 | 89.32* | 63.95 |
| ER on RTFO | Temp | | | | | | |
| Residue | (° C.) | | | | | | |
| Elastic Recovery (%) | 25 | 67.5 | 70.0 | 72.5 | 70.0 | 65.0 | 67.5 |
| MSCR on RTFO | Temp | | | | | | |
| Residue | (° C.) | | | | | | |
| Jnr 3.2 kPa (<=4.5) | 76 | 1.985 | 2.846 | 3.031 | 2.161 | 1.569 | 2.168 |
| Jnr Diff (<=75%) | 76 | 65.87 | 58.78 | 59.29 | 80.61* | 125.28* | 74.99 |
| Storage stability (48 hr cigar | | | | | | | |
| tube test) @ 163° C. | | | | | | | |
| G*(Pa), 76° C. | Top | 799.99 | 1132.99 | 1622.87 | 1251.84 | 1642.84 | 1688.37 |
| G*(Pa), 76° C. | Bottom | 2175.57 | 1813.15 | 1787.88 | 2133.63 | 2912.94 | 2013.75 |
| ABS(Top- | | 171.9* | 60.0* | 10.2 | 70.4* | 77.3* | 19.3 |
| Bottom)/Top, <=20% | | | | | | | |
| PG-MSCR grade | 70° C. | failed | failed | 70H | failed | failed | 70V |
| PG-MSCR grade | 76° C. | failed | failed | 76S | failed | failed | 76S |

*indicates a failing value.
¹Honeywell Titan ® 7686 is an oxidized high density, low molecular weight polyethylene. The Storage Stability test requires a ABS (Top-Bottom)/Top value 20% or less to pass the specification.

Blends #1, 2, 3, 4 and 5 produced in Table 1 followed a blending procedure of adding ground tire rubber to the molten base bitumen @ 180° C. and mixing for 2 hours at around 800 rpm in a low shear mixer. Blends #6 was produced by following the blending procedure of adding ground tire rubber followed by adding Honeywell Titan® 7686 to the molten base bitumen @ 180° C. and mixing for 2 hours at around 800 rpm in a low shear mixer.

Table 2 illustrates that about 12 weight percent GTR can be incorporated into a binder composition intended for roofing applications, at least when about 6 weight percent polyolefin is included in the binder composition as well. The asphalt may be free of SBS, and still pass the specifications for use. This can save on the cost, equipment, and time employed to incorporate the SBS into the asphalt. It also contains close to 70% recycled material of the total additive dosage, and the SBS blend (Blend #7) contains 0% recycled material.

TABLE 2

| Composition | | | Blend #7 | Blend #8 |
|---|---|---|---|---|
| Base Bitumen (NA PG 64-22) | | | 90.00% | 82.00% |
| SBS | | | 10.00% | |
| GTR (200 mesh) | | | | 12.00% |
| Honeywell Titan ® 8903 | | | | 4.00% |
| Honeywell Titan ® 8822 | | | | 2.00% |
| Total | | | 1.00 | 1.00 |
| | Temp | Spec (ASTM | | |
| Property | (° C.) | D 3462) | | |
| Viscosity, cPs | 204 | | 340 | 335 |
| Penetration, dmm | 25 | min 15 | 27.2 | 35 |
| Softening Point, ° C. | NA | 88-160 | 109 | 112.8 |
| recycled material (% of | | | 0 | 66.7 |
| total additive dosage) | | | | |

Honeywell Titan ® 8903 - oxidized high density, low molecular weight polyethylene.
Honeywell Titan ® 8822 - maleated, low molecular weight polypropylene.

Blend #7 in Table 2 was produced followed a blending procedure of adding SBS to the molten base bitumen @ 180° C. and mixing for 4 hours at around 5000 rpm in a high shear mixer. Blend #8 was produced by following the blending procedure of adding ground tire rubber followed by adding Honeywell Titan® 8903 and 8822 to the molten base bitumen @ 180° C. and mixing for 2 hours at around 800 rpm in a low shear mixer.

While several embodiments have been presented in the foregoing detailed description, it should be appreciated that a vast number of variations exist. It should also be appreciated that the embodiment or embodiments are only examples, and are not intended to limit the scope, applicability, or configuration of this disclosure in any way. Rather, the foregoing detailed description will provide those skilled in the art with a convenient road map for implementing various embodiments of the binder compositions, it being understood that various changes may be made in the function and arrangement of elements described without departing from the scope as set forth in the appended claims and their legal equivalents.

What is claimed is:

1. A binder composition comprising:
asphalt; and
ground tire rubber particles, wherein the ground tire rubber particles have a nominal product designation (Alternative US Sieve Size) defined by ASTM D5603-23 of equal or higher than about 200 mesh, and wherein the binder composition comprises the ground tire rubber particles in an amount of from about 5 to about 14 weight percent, based on a total weight of the binder composition;
wherein the binder composition is stable.

2. The binder composition of claim 1, further comprising:
a polyolefin in an amount of from about 0.5 to about 5 weight percent, based on the total weight of the binder composition.

3. The binder composition of claim 2, wherein the polyolefin comprises a low molecular weight polyolefin with a weight average molecular weight of from about 500 to about 30,000 Daltons.

4. The binder composition of claim 2, wherein the polyolefin comprises oxidized polyethylene with an acid number of from about 5 to about 60 mg KOH/gm.

5. The binder composition of claim 2, wherein the polyolefin is selected from the group of polyethylene homopolymers, polypropylene homopolymers, ethylene vinyl acetate (EVA), ethylene butyl acrylate (EBA), ethylene acrylic acetate (EAA), Fischer-Tropsch waxes, thermally degraded waxes with virgin or waste plastic feedstocks, by-product waxes, copolymers of two or more of ethylene, propylene, butene, hexene and octene, functionalized derivatives of the homopolymers mentioned above, functionalized derivatives of the copolymers mentioned above, and combinations thereof.

6. The binder composition of claim 2, wherein the polyolefin comprises maleated polypropylene with an acid number of from about 5 to about 50 mg KOH/gm.

7. The binder composition of claim 1, wherein the asphalt is free of styrene-butadiene-styrene.

8. The binder composition of claim 1, wherein the ground tire rubber particles are vulcanized.

9. The binder composition of claim 1, wherein the ground tire rubber particles are present in the binder composition in an amount of from about 8 to about 14 weight percent, based on the total weight of the binder composition.

10. The binder composition of claim 1, wherein the ground tire rubber particles are present in the binder composition in an amount of from about 8 to about 12 weight percent, based on the total weight of the binder composition.

11. The binder composition of claim 1, wherein the ground tire rubber particles are present in the binder composition in an amount of from about 10 to about 12 weight percent, based on the total weight of the binder composition.

12. The binder composition of claim 1, wherein the ground tire rubber particles are present as discrete particles in the binder composition.

13. A method of producing a binder composition comprising:
combining asphalt and ground tire rubber particles, where the ground tire rubber particles have a nominal product designation (Alternative US Sieve Size) defined by ASTM D5603-23 of equal or higher than about 200 mesh, to produce a premix asphalt material, and wherein the ground tire rubber particles are present in the premix asphalt material in an amount of from about 5 to about 14 weight percent, based on a total weight of the premix asphalt material; and
mixing the premix asphalt material to form the binder composition.

14. The method of claim 13, further comprising:
maintaining a mixing temperature of about 180° C. or during the mixing of the premix asphalt material.

15. The method of claim 13, further comprising:
maintaining a mixing shear, mixing temperature, and mixing time at levels below those required to dissociate a vulcanizate network of the ground tire rubber particles.

16. The method of claim 13, further comprising:
combining a polyolefin with the premix asphalt material in an amount of from about 0.5 to about 10 weight percent, based on the total weight of the binder composition.

17. The method of claim 16, wherein the polyolefin is a high density low molecular weight polyolefin with a weight average molecular weight of from about 500 to about 30,000 Daltons.

18. A binder composition, comprising:
asphalt in an amount of from 20 to 85 weight percent, based on a total weight of the binder composition;
ground tire rubber particles having a nominal product designation (Alternative US Sieve Size) defined by ASTM D5603-23 of equal or higher than about 200 mesh, in an amount of from about 5 to about 14 weight percent, based on the total weight of the binder composition; and
a polyolefin in an amount of from about 1 to about 10 weight percent, based on the total weight of the binder composition; and wherein;
the binder composition is stable.

19. The binder composition of claim 18, wherein the polyolefin is a high density low molecular weight polyolefin with a weight average molecular weight of from about 500 to about 30,000 Daltons.

20. The binder composition of claim 18, wherein the asphalt is free of styrene-butadiene-styrene.
